(19) United States
(12) Patent Application Publication
(10) Pub. No.: US 2013/0009929 A1
(43) Pub. Date: Jan. 10, 2013

(54) 3D LIQUID CRYSTAL SHUTTER GLASSES AND LENS THEREOF

(75) Inventor: WEN-WEI TSENG, Guangdong (CN)

(73) Assignee: LI-TEK CORPORATION CO., LTD., Guangdong (CN)

(21) Appl. No.: 13/178,527

(22) Filed: Jul. 8, 2011

(51) Int. Cl. G09G 5/00; G02F 1/1335

(52) U.S. Cl. 345/211; 349/13

(57) ABSTRACT

3D liquid crystal shutter glasses include a pair of LCD lenses (1), and a control circuit (100) associated with the LCD lenses. The LCD lens includes an LCD-glass layer (2), a front polarizing filter (3), and a transparent scratchproof layer (4) laminated together. The control circuit includes a sync signal receiver (5), an LCD driver (6) for controlling LCD lenses, a boost circuitry (7) associated with LCD driver for outputting a drive voltage to the LCD driver, a CPU (8) which is respectively associated with the receiver, LCD driver, and boost circuitry for controlling operation of the same, and a power supply module (11) for powering the control circuit. The lenses prevent light in environment affecting and flaring thereon. The light transmittance of the lenses is approximated to 40%. Accordingly, the 3D glasses present the user brighter and lively image in higher quality, and avoid hurting user's eyesight.

### BACKGROUND OF THE INVENTION

The present invention relates to an image or video viewing systems and apparatuses, and especially to 3D liquid crystal shutter glasses and lens thereof.

In nowadays, three dimensional (3D) image display technology is applied in a wide variety of fields, including stereoscopic movie, amusement park, liquid crystal television (LCTV), and the like. The user needs to wear a pair of 3D glasses for viewing displayed 3D image or video. However, the light in the environment tends to impact the quality of image or video displayed by 3D glasses. Light in the environment such as fluorescent lamp, three-wavelength lamp, ultraviolet lamp, or any other light, will impact the lenses of 3D glasses flashing or glaring thereon, and accordingly affect the user viewing image. Furthermore, light transmittance of the traditional 3D glasses is less than 37%, the image or video perceived by the user via the 3D glasses is poor in quality, which will hurt the eyes of the user.

Therefore, an improved 3D liquid crystal shutter glasses and lens thereof are desired which overcomes the disadvantages of the prior art.

### BRIEF SUMMARY OF THE INVENTION

A main object of the present invention is to provide a pair of 3D liquid crystal shutter glasses and lens thereof, which can eliminate the impact from light in environment, and improve the viewing effect and quality of 3D image or video.

To obtain the above object, 3D liquid crystal shutter glasses in the present invention comprise left and right LCD lenses, and a control circuit associated with the LCD lenses. The LCD lens of the 3D liquid crystal shutter glasses comprises a liquid crystal and glass laminated layer (short for LCD-glass layer), a front polarizing filter, and a transparent scratchproof layer. The front polarizing filter and transparent scratchproof layer are respectively laminated on a front and back faces of the LCD-glass layer. Thereby, left and right lenses prevent light in environment affecting and flaring thereon. Moreover, the light transmittance of the lenses is approximated to 40%. Therefore, the 3D glasses present the user brighter and lively image in higher quality, and avoid hurting user's eyesight.

The LCD-glass layer comprises a pair of opposite glass and liquid crystal sandwiched therebetween. The transparent scratchproof layer is made from a film of polyethylene terephthalate (PET) or polycarbonate (PC). The front polarizing filter may further have a transparent scratchproof layer covered thereon. Therefore, the glass and polarizing filter can be protected from scratched.

The control circuit comprises: a sync signal receiver; an LCD driver for controlling operation of LCD lenses; a boost circuitry associated with LCD driver for outputting a drive voltage to the LCD driver; a CPU which is respectively associated with the receiver, LCD driver, and boost circuitry for controlling operation of the same; and a power supply module for powering the control circuit. The power supply module comprises battery and a power control module; and the power control module is associated with the battery to control the battery recharging. The battery is operable to supply power for the control circuit via the power control module.

In operation, the CPU controls the receiver to receive sync signals from a sync transmitter in an external source; according to the sync signal, the CPU outputs a command to the LCD driver for driving the LCD lens operation, and a command to the boost circuitry to power the LCD driver. According to the commands from the CPU, the boost circuitry outputs a drive voltage to the LCD driver, whereby the LCD driver starts to control the LCD lenses to turn on and off.

Other objects, advantages and novel features of the invention will become more apparent from the following detailed description of a preferred embodiment thereof when taken in conjunction with the accompanying drawings, wherein:

### BRIEF DESCRIPTION OF THE DRAWINGS

FIG. 1 is a diagrammatic view of 3D liquid crystal shutter glasses in accordance with an embodiment of the present invention;

FIG. 2 is an exploded, illustrative view of LCD lens of the 3D liquid crystal shutter glasses of FIG. 1;

FIG. 3 illustrates a schematic diagram of the 3D liquid crystal shutter glasses of FIG. 1 in accordance with a first embodiment; and

FIG. 4 illustrates a schematic diagram of the 3D liquid crystal shutter glasses of FIG. 1 in accordance with a second embodiment.

### DETAILED DESCRIPTION OF THE INVENTION

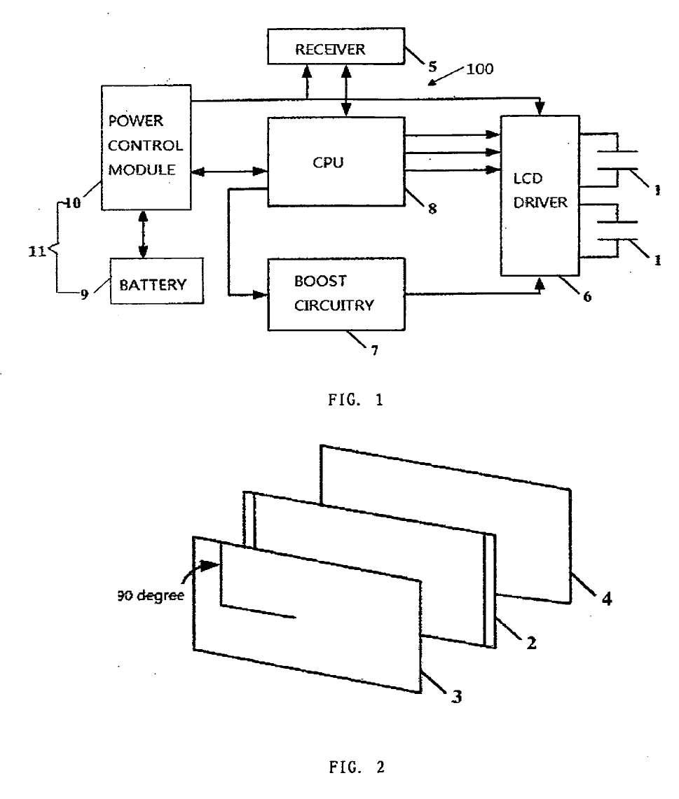

Referring to FIG. 1, 3D liquid crystal shutter glasses according to the embodiment of the present invention include left and right LCD lenses 1 and control circuit 100 associated with LCD lenses 1. Referring to FIG. 2 together, the LCD lens 1 comprises a front polarizing filter 3, a liquid crystal and glass lamination (also as LCD-glass layer) 2, and a transparent scratchproof layer 4. The front polarizing filter 3 has (but not limited to) 90-degree polarization in an exemplary implement. The LCD-glass layer 2 comprises a pair of opposite glass and liquid crystal (not shown) sandwiched therebetween. The transparent scratchproof layer 4 is made from a film of polyethylene terephthalate (PET) or polycarbonate (PC). The front polarizing filter 3 is laminated on the LCD-glass layer 2 in front face thereof, and the transparent scratchproof layer 4 is covered on back of the LCD-glass layer 2, which constructs the lenses 1 in a form of plural layers.

It is understood that the LCD lens 1 may further have a transparent scratchproof layer covered on front polarizing filter. Therefore, the glass and polarizing filter can be protected from scratched.

Since the lens 1 of the present invention omits a back polarizing filter, when the left and right lenses 1 flip up and down, the viewer cannot perceive flashing or glaring of light in environment. Additionally, the LCD display of TV also has a 90-degree polarizing filter thereon, when the left and right lenses 1 of the 3D glasses opposite to the LCD display of TV flip up and down, thus forms a visual-angle difference relative to the polarizing filter of TV display, and forms a switch of on/off to present 3D image thereon. Accordingly, the left and right lenses 1 prevent light in environment affecting and flaring thereon. Moreover, the light transmittance of the lenses 1 is approximated to 40%. Therefore, the lenses 1 of 3D glasses present the user brighter and lively image in higher quality, and avoid hurting user's eyesight.

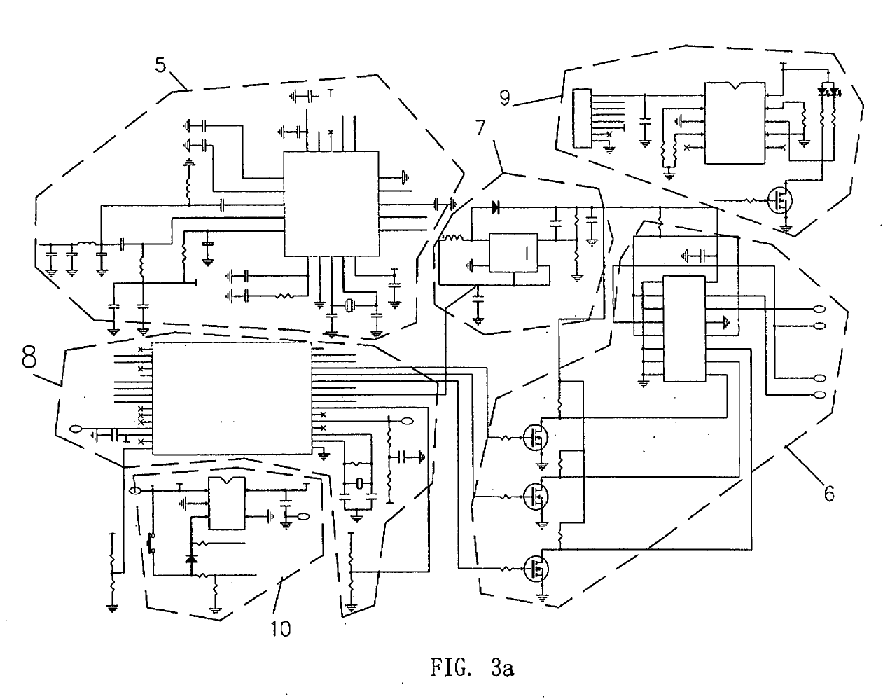

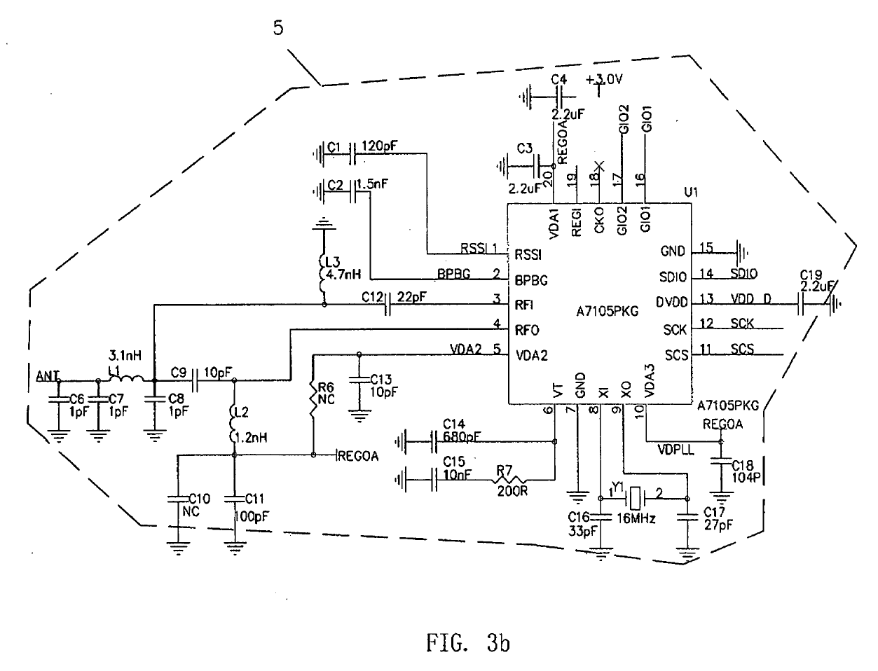

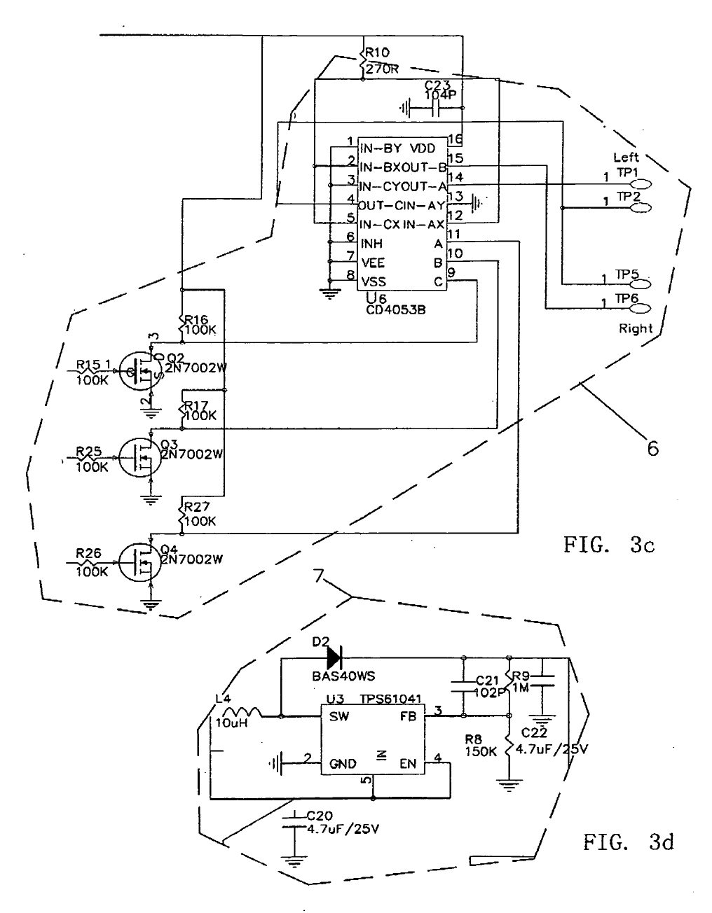

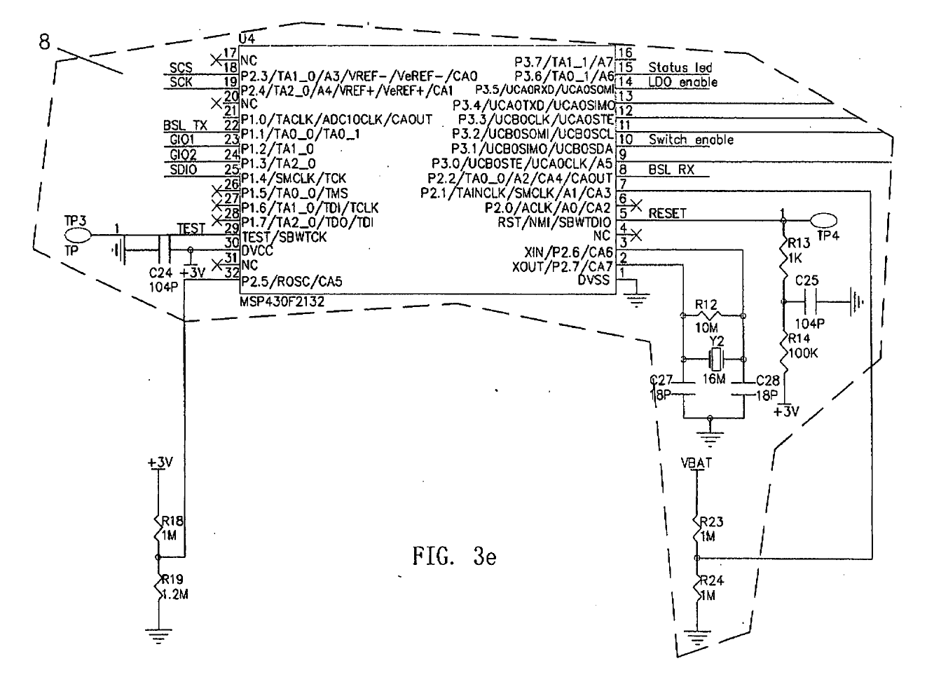

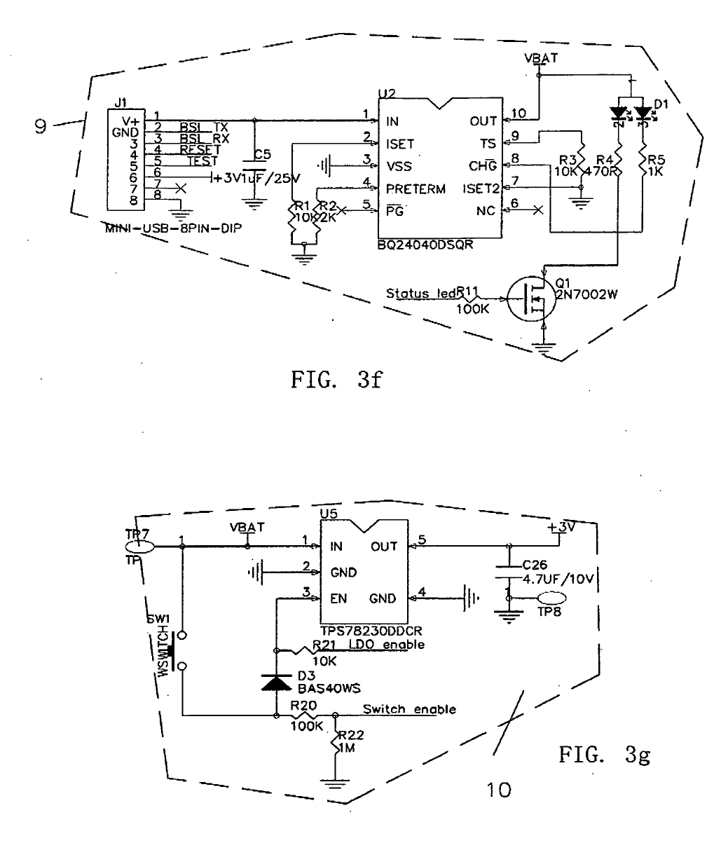

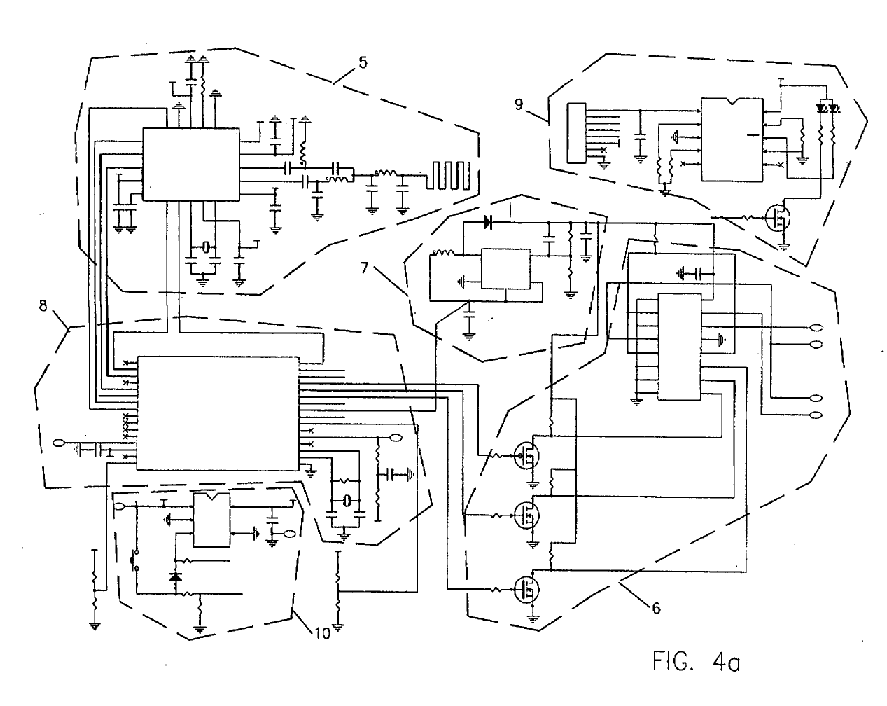

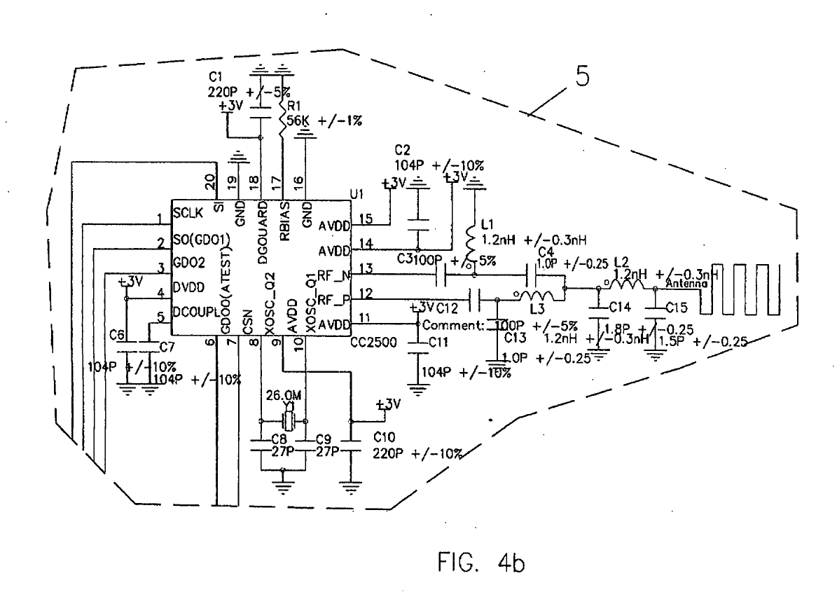

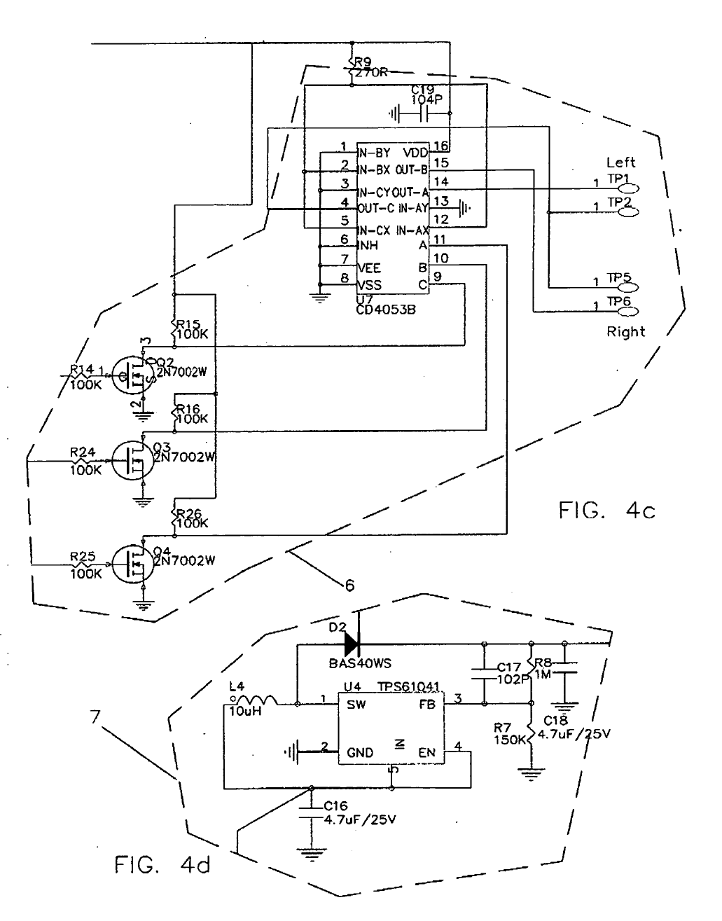

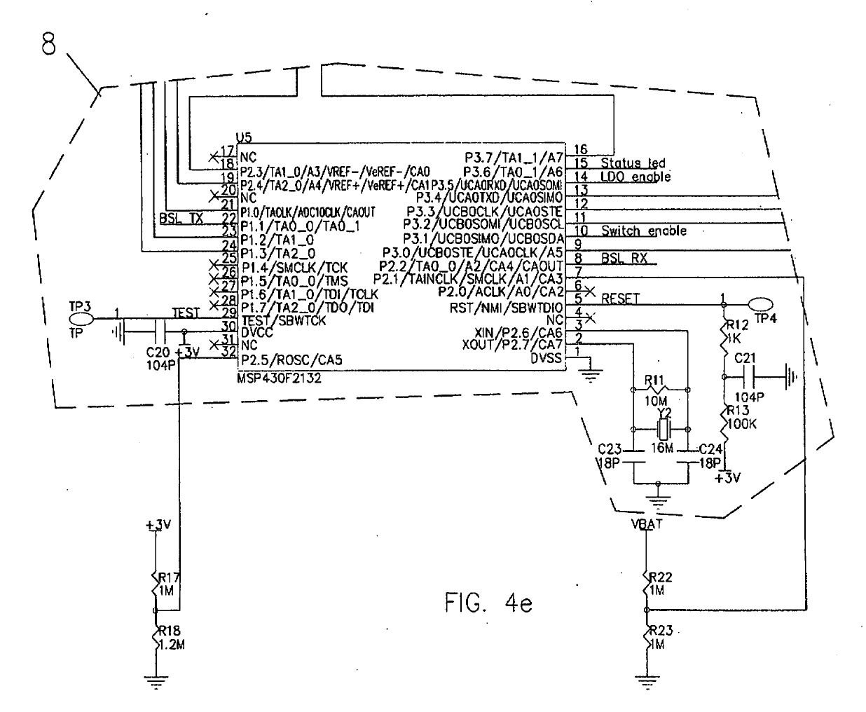

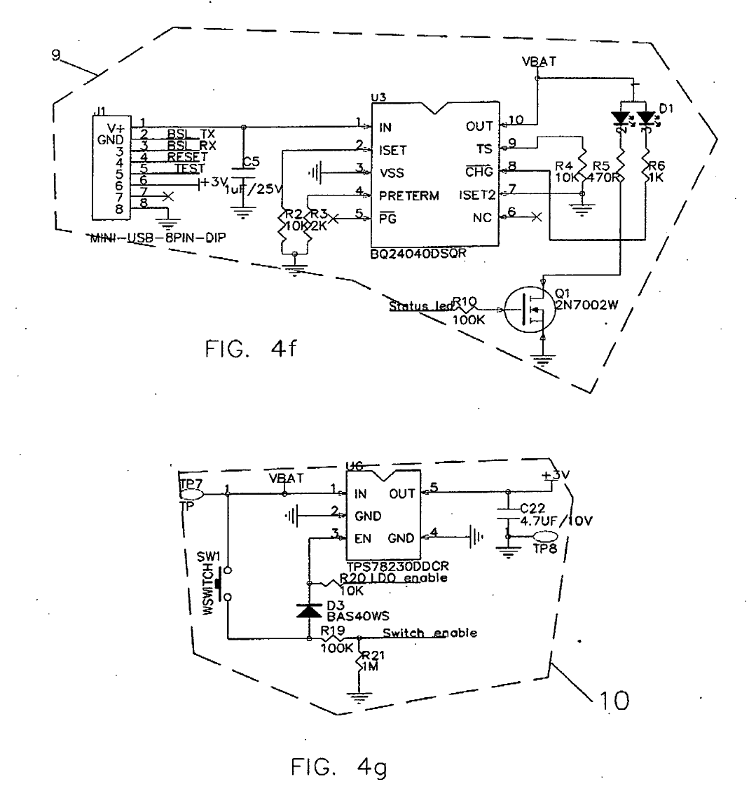

Referring to FIG. 1 again, the control circuit 100 associated with LCD lenses 1 comprises: sync signal receiver 5, LCD driver 6, boost circuitry 7, central processing unit (CPU) 8, and power supply 11 electronically associated in the way as shown in FIG. 1. The power supply 11 includes battery module 9 and power control module 10. FIGS. 3 and 4 respectively illustrate a specific electronic circuit diagram of the control circuit 100 in two embodiments, which are also protected in the scope of this invention.

The signal receiver 5 for receiving synchronization signal is an RF receiver, which may be selective from (but not limited to) a chip of CC2500 or A7105. The LCD driver 6 is operable to control LCD lenses 2. The LCD driver 6 may be selective from (but not limited from) a chip of CD4053. The boost circuitry 7 is associated with the LCD driver 6 and output a drive voltage to the LCD driver 6. The CPU 8 is respectively associated with the RF receiver 5, LCD driver 6 and boost circuitry 7 so as to control them working. The power control module 10 is associated with battery module 9. The power control module 10 is operable to power the RF receiver 5, LCD driver 6, boost circuitry 7 and the CPU 8, and control recharging the battery module 9. The CPU 8 may be selected as but not limited to the type of MSP430F2121 or MSP430F2132. The battery module 9 preferably is lithium battery, and is operable to supply power to the control circuit 100 via the power control module 10.

When the 3D glasses in operation, the RF receiver 5 is provided to receive a synchronization signal from an external source which comes from a sync signal transmitter linked to a liquid crystal TV, digital projector, computers or any other three-dimensional or stereoscopic devices. The CPU 8 controls the RF receiver 5 receiving proper signals, and then output commands respectively to the LCD driver 6 and the boost circuitry 7. According to the commands from the CPU 8, the LCD driver 6 and the boost circuitry 7 start to work, and the boost circuitry 7 outputs a drive voltage to the LCD driver 6. More specifically, when the RF receiver 5 receives a sync signal, the CPU 8 will output a command according to the sync signal to the LCD driver 6, and at the same time initiate the boost circuitry 7 to power the LCD driver 6, finally, the LCD lenses 1 are prompted by the driver 6 to turn on and off accordingly.

The boost circuitry 7 is controlled by the CPU 8 to power the LCD driver 6. When the boost circuitry 7 is input a starting signal (command) from the CPU 8, it will output a power signal (namely, power voltage or drive voltage) to LCD driver 6 so that the driver 6 is energized to control the LCD lens to turn on/off according to the command from CPU 8.

The LCD driver 6 is controlled by the CPU 8, and is operable to drive the LCD lenses 1. When the driver 6 is input a control signal (command) from the CPU 8 and a drive voltage from the boost circuitry 7, it will operate according to the command from CPU 8 to control the left lens 1 or the right lens 1 to turn on or off.

The power control module 10 is operable to control the battery 9 recharging, and employs a regular voltage regulator such as a low dropout regulator (LDO) for voltage-stabilizing. Furthermore, the power control module 10 is operable to supply operating voltage to the RF receiver 5, the LCD driver 6, boost circuitry 7, and CPU 8.

The lithium battery 9 as a power source is operable to power the whole control circuit 100.

It is understood that the signal receiver 5 can also be designed as an infrared (IR) receiver or the like instead of RF receiver.

While the invention has been described in conjunction with specific embodiments, it is evident that numerous alternatives, modifications, and variations will be apparent to those skilled in the art in light of the forgoing descriptions. The scope of this invention is defined only by the following claims.

What is claimed is:

1. LCD lens of 3D liquid crystal shutter glasses comprising:
an LCD-glass layer;
a front polarizing filter; and
a transparent scratchproof layer;
wherein said front polarizing filter and transparent scratchproof layer are respectively laminated on a front and back faces of said LCD-glass layer.

2. The LCD lens according to claim 2, wherein said front polarizing filter has 90-degree polarization.

3. 3D liquid crystal shutter glasses comprising:
a pair of LCD lenses; and
a control circuit associated with said LCD lenses;
wherein said LCD lens comprises an LCD-glass layer and a front polarizing filter;
and the front polarizing filter is laminated on a front surface of said LCD-glass layer.

4. The 3D liquid crystal shutter glasses according to claim 3, wherein said LCD lens further comprises a transparent scratchproof layer covered on back surface of the LCD-glass layer.

5. The 3D liquid crystal shutter glasses according to claim 3, wherein said control circuit comprises:
a sync signal receiver;
an LCD driver for controlling operation of LCD lenses;
a boost circuitry associated with LCD driver for outputting a drive voltage to said LCD driver;
a CPU respectively associated with said receiver, LCD driver, and boost circuitry for controlling operation of said receiver, LCD driver, and boost circuitry; and
a power supply module for powering said control circuit.

6. The 3D liquid crystal shutter glasses according to claim 5, wherein said receiver is a kind of RF or infrared receiver.

7. The 3D liquid crystal shutter glasses according to claim 5, wherein said power supply module comprises battery and a power control module; said power control module is associated with said battery to control said battery recharging.

8. The 3D liquid crystal shutter glasses according to claim 7, wherein said battery is operable to supply power for said control circuit via said power control module; and said power control module employs a regular voltage regulator for voltage-stabilizing.

9. The 3D liquid crystal shutter glasses according to claim 7, wherein said battery is a lithium battery; and said voltage regulator is a kind of LDO.

10. The 3D liquid crystal shutter glasses according to claim 5, wherein the CPU controls the receiver to receive proper signals, and then outputs commands respectively to the LCD driver and the boost circuitry.

11. The 3D liquid crystal shutter glasses according to claim 10, wherein the receiver receives sync signal from a sync transmitter in an external source; according to the sync signal, the CPU outputs a command to the LCD driver for driving the LCD lens operation, and a command to the boost circuitry to power the LCD driver.

12. The 3D liquid crystal shutter glasses according to claim 11, wherein according to the commands from the CPU, the boost circuitry outputs a drive voltage to the LCD driver, whereby said LCD driver starts to control the LCD lenses to turn on and off.

13. The 3D liquid crystal shutter glasses according to claim 1, wherein the LCD-glass layer comprises a pair of opposite glass and liquid crystal sandwiched therebetween.

14. The 3D liquid crystal shutter glasses according to claim 1, wherein the transparent scratchproof layer is made from a film of polyethylene terephthalate or polycarbonate.

15. The 3D liquid crystal shutter glasses according to claim 1, further comprising a second transparent scratchproof layer covered on the front polarizing filter.
